(19) United States
(12) Patent Application Publication
(10) Pub. No.: US 2014/0024289 A1
(43) Pub. Date: Jan. 23, 2014

(54) BEE FRAME AND INSERT FOR A BEE FRAME WITH PEST CONTROL

(71) Applicant: Péter Fendrik, Sojtor (HU)

(72) Inventor: Péter Fendrik, Sojtor (HU)

(21) Appl. No.: 14/000,136

(22) PCT Filed: Feb. 22, 2012
(86) PCT No.: PCT/HU2012/000015

§ 371 Date: Sep. 18, 2013

(30) Foreign Application Priority Data
Feb. 22, 2011 (HU) P1100100

(51) Int. Cl. A01K 51/00; A01K 47/02

(52) U.S. Cl. CPC A01K 51/00; A01K 47/02
USPC 449/42

(57) ABSTRACT

The present invention refers to a bee frame (1) comprising a frame (10) with tabs (111, 112) and a comb base (16) fixed in the inside of the frame (10), wherein the frame (10) is divided into two frame parts (10′, 10″) along a central symmetry plane (T) parallel with the main plane of the frame (10), and comb bases are fixed (16′, 16″) in the inside of the individual frame parts (10′, 10″) and the two frame parts (10′, 10″) containing the respective comb bases (16′, 16″) can be closely joined to each other and can be separated from each other along the opposing surfaces of the two frame parts (10′, 10″).

### FIELD OF THE INVENTION

The present invention refers to a bee frame, in particular to a bee frame applicable to prevent and attenuate diseases of honey bees, which may bring about considerable damages in bee colonies.

Further, the present invention refers to an insert for pest treatment to be used in said bee frames.

### BACKGROUND ART

The health and wholeness of honey bees is greatly influenced by various mite species proliferating in bee hives as potential parasites. Mites are present both on the body of fully developed adult bees and in the capped brood cells of the frames and these mites suck the blood of bees. Presence of the mites considerably weakens the immune system of bees, reduces their ability to withstand diseases or infections, thus their lifetime gets shorter. There is a wide range of methods to eliminate or suppress mites, which methods can be divided into four groups. The first is (i) biological methods like frequent elimination of the capped brood cells, disturbing the reproduction of mites by pheromones and elimination of mites by entomopathogenic fungi; (ii) treatments by chemicals such as organic acids (e.g. formic acid, oxalic acid), medicines, natural essences (e.g. thymol, menthol, camphor, peppermint), treatment with chemical compositions (e.g. kumaphos, amitraz, permethrin, fluvalinate); (iii) (biological) traps and (iv) physical methods (treatment by powdered sugar).

Bee-keepers face the biggest difficulty due to the fact that the elimination of mites from capped brood cells—covered by the bees with wax—is extremely difficult with methods belonging to groups (i)-(iv). In the capped brood cells the mites are less vulnerable and their termination in all stages of the breeding cycle is less effective than in the case of adult mites which stay on the body of an adult bee. Thus, presently there is no effective method available to intervene into the breeding cycle of the mites while they go through their metamorphic development in the brood cells of bees.

Hungarian patent No. 223 065 B1 discloses a solution where the brood cycle of mites is suppressed by rotation of the bee frames. The effectiveness of this method is not sufficiently supported by scientific evidences and is not regarded as a widespread method in the relevant technical field.

In U.S. Pat. No. 6,475,061 B1 termination of mites raising in the brood cells is carried out by heating an ohmic heating wire which is positioned within the bee frame containing brood cells. Together with the mites the bee larvae in the brood cell is also terminated. The same effect can be achieved by more simple methods, e.g. by manually removing the infected brood cells, thus, this method offers no considerable advantage. Further disadvantage is that this method can be used exclusively in specific seasons of the year—on the northern hemisphere e.g. it is applied in the spring, simultaneously with the expansion of breeding.

Patent No. GB 592,090 discloses a honeycomb for a beehive comprising a block of open-ended hexagonal cells formed from juxtaposed and united strips of corrugated material, a sheet bearing on its outer side similarly disposed facets of similar hexagonal section and means for supporting the block so that the inner ends of the cells register with and abut the outer ends of the facets on the sheet. The honeycomb comprises two of said sheets with blocks of hexagonal cells on their outer sides, and the inner sides of the two said sheets converge upwardly together. The blocks of hexagonal cells can be separated from the respective sheets and in this way the honey contained in the cells can be collected from the rear side of the hexagonal blocks. This arrangement is not suitable for the treatment of bee diseases.

In order to overcome the above deficiencies of prior art solutions the present invention is aimed at providing a method which is capable to intervene into the brood cycle of mites and other types of parasites. In this manner the effectiveness of biological and chemical treatments is enhanced and the proliferation of mite populations and other parasites is diminished to a minimum amount. The method is designed to work at a location—i.e. in the capped brood cells—where known preventive solutions of the prior art failed to exhibit sufficiently good results or cannot be applied at all.

The invention is based on the idea that when a conventional bee frame comprising a comb base is cut into two halves along a plane parallel with the main plane of the frame then the comb cells become accessible from the inner surface of the resulted half frame parts—i.e. from the rear side of the comb cells—in order to perform pest treatments. Initially, the frame parts are joined together and the bees build up the comb cells on the respective outer surfaces of the two comb bases, whereas during pest treatment the frame parts are separated and the comb cells become accessible from the rear side.

The invention is further based on the idea that the comb cells must be perforated on their rear walls and this way pathogenic organisms that present in the comb cells can be reached.

The above goals are achieved by a bee frame comprising of a supporting frame with end bars and a comb base placed in the middle of the supporting frame wherein the supporting frame is divided into two frame parts along a plane parallel with the main plane of the supporting frame, and within each frame part a respective comb base is fixed, and wherein the two frame parts containing the respective comb bases are formed in a way that they can be closely joined together or can be separated along their opposing surfaces.

According to another aspect of the invention the above goals are achieved by an insert for pest treatment which is to be applied in cooperation with said bee frame; the insert has a thin substrate, the substrate is provided at least on one side with pins which are longer than the thickness of the comb bases applied in the bee frame and contain a biological agent applicable for pest control and wherein the pins are aligned according to a predetermined pattern.

Preferred embodiments of the invention are described in the dependent claims.

In the following description the preferred embodiments of the invention will be described in detail with reference to the attached drawings wherein in

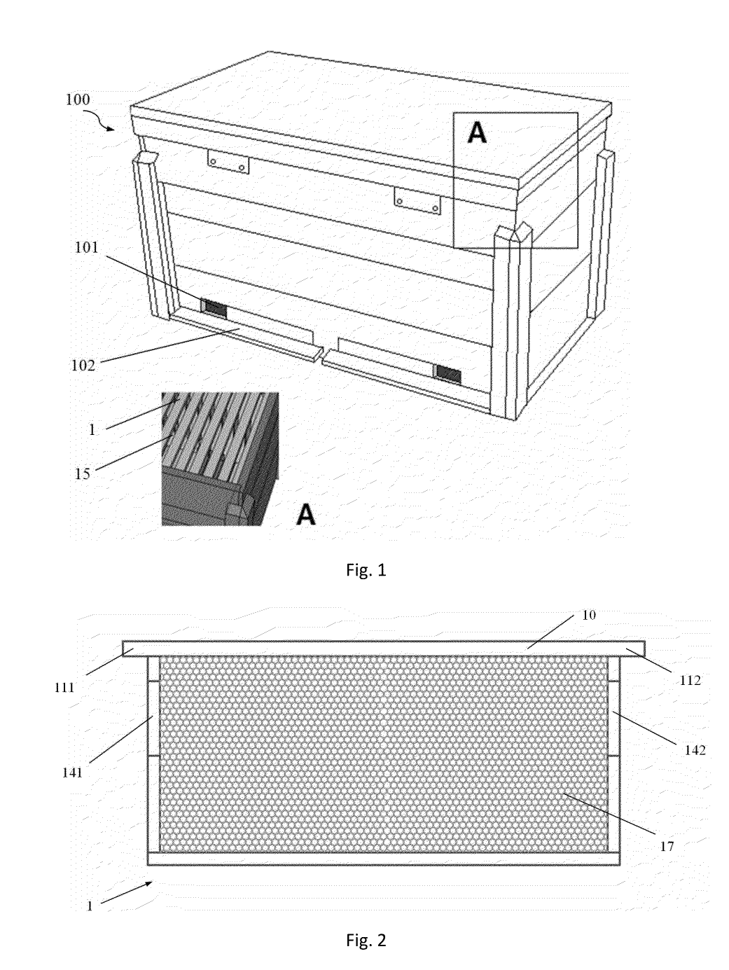

FIG. 1 a common bee hive is shown in perspective view, in

FIG. 2 a conventional bee frame is shown in front view, in

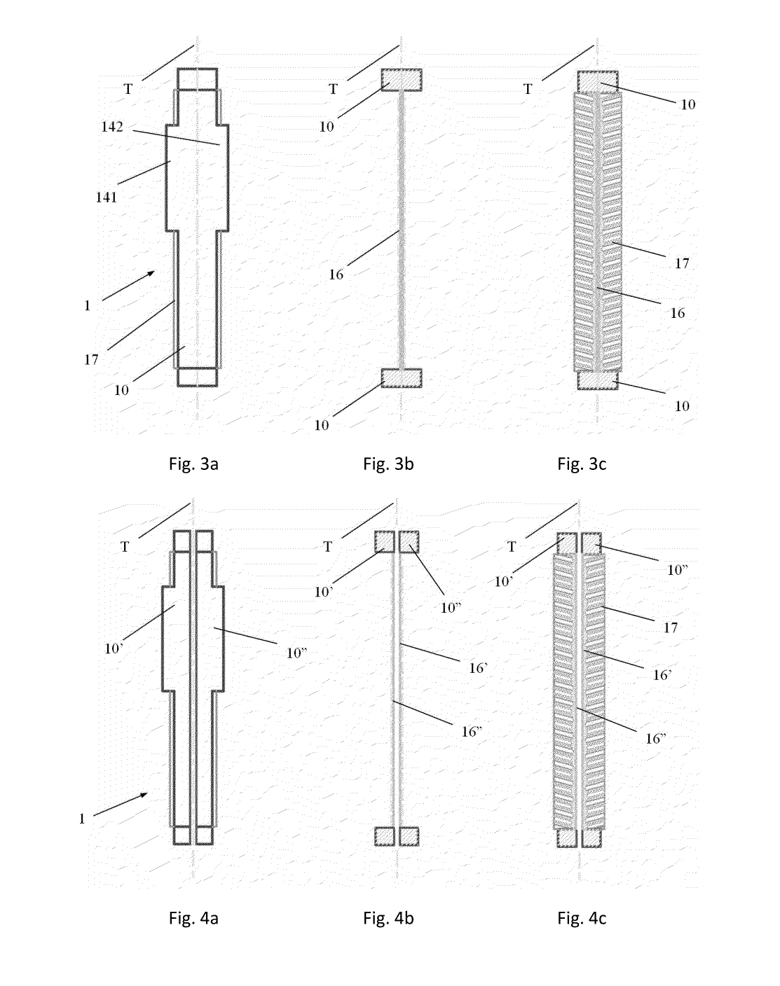

FIG. 3a a conventional bee frame is shown in side view, in

FIG. 3b a conventional bee frame is shown in cross-sectional side view comprising a comb base, in

FIG. 3c a conventional bee frame is shown in cross-sectional side view comprising a comb base and comb cells built up on the two opposite sides of the comb base, in

FIG. 4a the bee frame of the present invention is shown in side view, in

FIG. 4b the bee frame of the present invention is shown in cross-sectional side view comprising two separate comb bases, in

FIG. 4c the bee frame of the present invention is shown in cross-sectional side view comprising two comb bases and respective comb cells built up on the outer sides of the comb bases, in

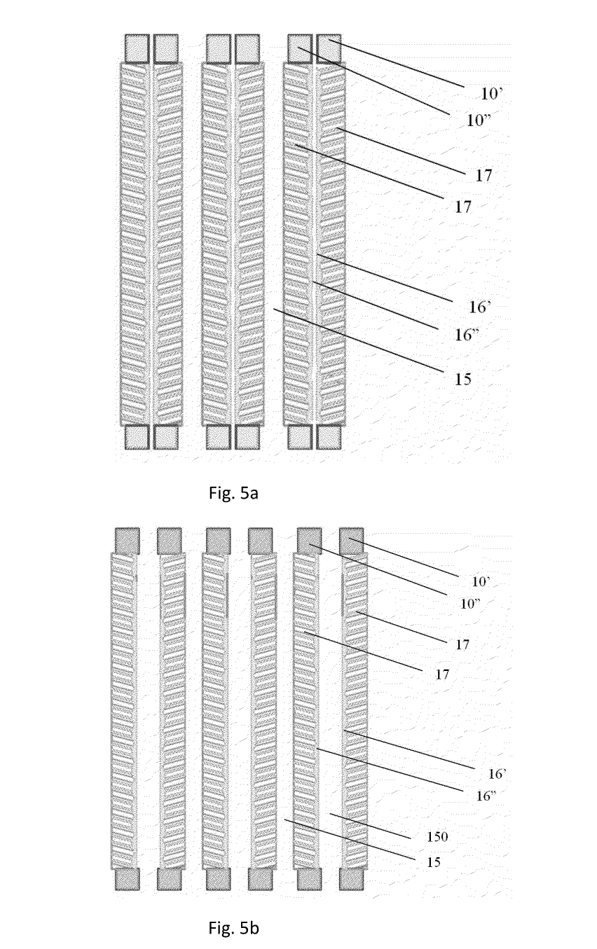

FIG. 5a a plurality of adjacent bee frames of the invention are shown in closed position, in

FIG. 5b a plurality of bee frames of FIG. 5a are shown in open position, in

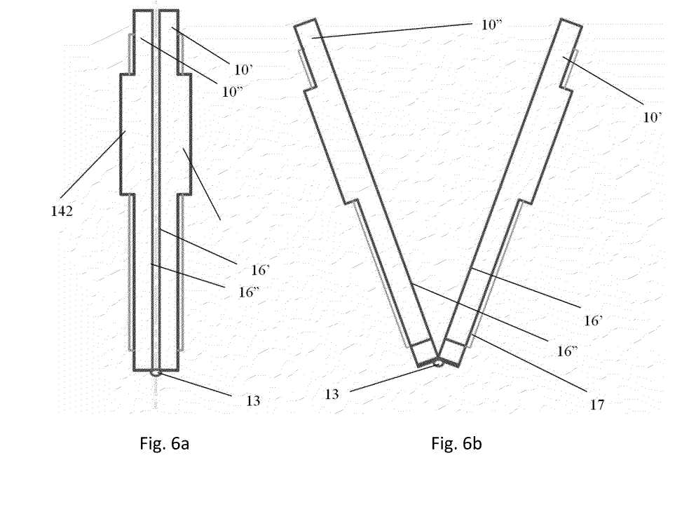

FIG. 6a an embodiment of the bee frame of the invention is shown with a hinged opening means in its closed position, in

FIG. 6b another embodiment of the bee frame of the invention is shown with a hinged opening means in its opened up position, in

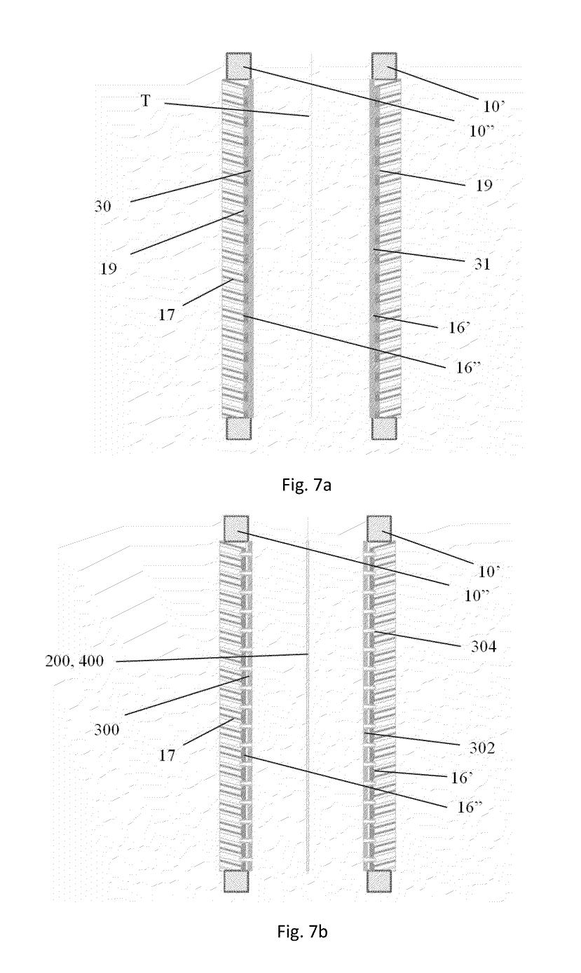

FIG. 7a we show an insert which is applied in cooperation with the bee frame of the present invention and which is applicable to form perforations on the comb base, in

FIG. 7b we show another insert which is applied in cooperation with the bee frame of the present invention and which is applicable in the treatment of bee diseases.

### DETAILED DESCRIPTION OF THE INVENTION

In FIG. 1 there is shown a conventional bee hive 100 in perspective view. On the front side of the bee hive 100 an entrance opening 101 is arranged enabling the bees to enter and exit the hive. In front of the entrance opening 101 landing board 102 is installed to facilitate the landing of bees. Detail “A” of FIG. 1 is shown separately with the only difference that in section “A” the lid of the bee hive 100 is in an opened up position. As it is seen in the figure, in the bee hive 100 a plurality of bee frames 1 are arranged parallel to each other. Passage ways 15 extend between the bee frames 1, which ensure the free movement of the bees within the hive.

In FIG. 2 a conventional bee frame 1 consisting a plurality of comb cells 17 is depicted in front view. The bee frame 1 is comprised of a supporting frame 10 and end bars 111 and 112 extending over the respective ends of the upper bar of the frame. The bee frames 1 are hanging in the bee hive 100 with their end bars 111, 112 being supported by suitable abutting surfaces. In this way they are easily accessible for the bee-keeper and can be manipulated in a handy way. The dimensions of the bee frame 1 may vary on a wide scale. The frames 1 contain shoulders 141, 142 on their side bars.

In FIG. 3a a conventional bee frame is shown in side view. It is clearly seen that the frame 1 has a structure which is symmetrical to a central plane T parallel with the main plane of the frame. From the side bars of the supporting frame 10 shoulders 141, 142 are protruding in the front and backward directions. Two adjacent bee frame 1 touch each other within the bee hive 100 along their shoulders 141, 142. The shoulders 141, 142—as spacers—have an overall width such that the passage way formed between two adjacent bee frames 1 has a size typically applied in the technical field, which is 7-16 mm. Spaces smaller or larger than this value are built in with wax by the bees.

In FIG. 3b the bee frame 1 of FIG. 3a is shown in cross-sectional side view. The bee frame 1 contains a comb base 16 made of beeswax. The comb base 16 may be fixed in a conventional manner, e.g. with the aid of span-wires (through melting into the span-wires) expanding between opposing bars of the supporting frame 10.

In FIG. 3c a bee frame of FIG. 3a is shown in cross-sectional side view with a comb base 16 and comb cells 17 built up on the two opposite sides of the comb base 16. Bees build up the typically hexagonal shape comb cells 17 on each side of the comb base 16. The comb base 16 and comb cells 17 together form a comb. A comb which has been built up in a natural way by the bees always contains two rows of cells, i.e. one on each side of the comb base 16. The openings of comb cells 17 face towards the passage ways 15 of FIG. 1 so that the comb cells 17 are penetrable always only from one direction, i.e. from the passage ways 15 and their rear side on the comb base 16 is closed by wax.

In FIG. 4a the bee frame 1 of the present invention is shown in side view. The bee frame 1 is symmetrical to a central plane T parallel to the main plane of the frame. From the side bars of the supporting frame 10 shoulders 141, 142 are protruding in the front and backward directions. The supporting frame 10 is divided into two parts along the central plane T. In FIG. 4b which is a cross-sectional side view of the bee frame 1 of FIG. 4a it is seen that the supporting frame 10 divided along central plane T has two frame parts 10′, 10″, in each of which a respective 16′, 16″ comb base is fixed. In FIG. 4c we show that the bees build up the comb cells 17 on the outer side of each comb bases 16′, 16″ fixed in the respective frame parts 10′, 10″. In FIG. 4c going from the left to the right the following layers can be inspected: left comb cells 17, (left) first comb base 16′, (right) second comb base 16″, right comb cells.

Since the frame parts 10′, 10″ can be densely and stably packed adjacent to each other in the bee hive 100, wherein the frame parts are suspended by the respective end bars 111, 112 and shoulders 141, 142 touch the neighboring shoulder, when the bee frame 1 of the invention is placed into the hive 100 the typical passage ways 15 are formed according to FIG. 5a.

In the first preferred embodiment of the inventive bee frame the frame parts 10′, 10″ are provided as separated or separable elements, and they can be removed from the hive 100 independently. During pest treatment, i.e. in an active state, the frame parts 10′, 10″ are separated from each other and are placed separately into the bee hive and a spacing 150 is formed between them as shown in FIG. 5b. In this case either the bee-keeper or the bees themselves can reach the comb cells 17 from the rear side, which enables them to proceed with a natural or artificial way of pest treatment.

In the second preferred embodiment of the inventive bee frame 1 the frame parts 10′, 10″ are joined to each other along one of their bars by means of one or more hinge-joints or by an equivalent connecting element 13 as depicted in FIGS. 6a and 6b. This arrangement makes possible to move the frame parts 10′, 10″ together or to open the frame parts 10′, 10″ in order to carry out a pest treatment either within or outside of the hive 100. In the default position the frame parts 10′, 10″ are tightly joined together in the hive so that the bees are able to build up the comb cells 17 on the outer sides of each comb bases 16′, 16″ of the respective frame parts 10′, 10″. During pest treatment the frame parts 10′, 10″ can be opened up by means of the connecting element 13, and thus easy access is rendered to the rear side of the comb cells 17.

In the first and second embodiments access to the pathogen organisms and detection of infected frame brood cells can be facilitated by the perforation of the comb bases 16′, 16″. Perforation 19 can be formed e.g. by a sheet or insert 31 which is applied to the comb bases 16′, 16″ and is subsequently removed. Such exemplary sheet 31 is shown in FIG. 7a. Removal of the sheet 31 can be effected by peeling it off—together with protrusions formed on its surface—from the comb bases 16′, 16″, resulting in a perforation 19 which is superimposed on the comb cells 17. In the first embodiment as a result of the separation of the frame parts 10′, 10″ a new bee passage way 150 might be formed. After removal of the perforating sheet 31 the bees can more easily perceive infectious diseases of the brood cells from the direction of comb bases 16′, 16″. In case of having sufficiently high innate cleaning aptitude, the bees may remove the infected growing larvae together with the varroa mites in all breed cycles by approaching these from the rear side of the comb cells 17 of the comb bases 16′, 16″ while they move along the new passage way 150 and will also restore the damages of the comb cells 17 by their innate building aptitude. The perforating sheet 31 can be put back in place on the comb base. The frame parts 10′, 10″ can be again joined together, and the bee frame can be used in the conventional way. In the second embodiment after the frame parts 10′, 10″ have been opened the perforating sheet 31 can be removed from the rear side of the comb bases 16′, 16″ and chemicals used in the required treatments, e.g. compositions used in the treatment of bee diseases which evaporate into the comb cells 17, e.g. medicaments, chemical compositions, natural essences, organic acids etc. or an insert soaked with these materials can be placed in between the frame parts 10′, 10″ from the rear side of the comb cells 17. The frame parts 10′, 10″ after being closed and containing the materials for pest treatment are placed back into the bee hive 100. In another embodiment between the two frame parts 10′, 10″ a separator sheet (not shown) can also be applied. The separator sheet is not able to create perforations 19 but is used to prevent sticking of the wax material of the comb bases 16′, 16″.

In the course of the pest treatment method used in connection with the inventive bee frame the comb bases 16′, 16″ are fixed within the respective frame parts 10′, 10″ of the frame 1, a separator sheet is inserted in between the comb bases 16′, 16″ and the frame parts 10′, 10″ are placed into the hive while they are tightly joined to each other. The separator sheet may contain a material suppressing the proliferation of wax moth. Instead of the separator sheet two perforating sheets 31 can also be applied onto the respective comb bases 16′, 16″ according to FIG. 7a. The bee frame 1 is supplied to the bee colony in a closed state and the frame 1 will be arranged in a bee hive 100 in a usual manner. The bees work out the comb bases 16′, 16″ on the side facing the “natural” passage ways 15 for instance with the aid of a wax coating, which means that the bees form the comb cells 17 on each comb bases 16′, 16″. After the queen has laid eggs in the cells and the comb contains mainly capped brood cells, the frame 1 may be activated to perform pest control.

In the course of the pest treatment method connecting to the first embodiment initially the frame 1 is pulled out of the bee hive 100, the frame parts 10′, 10″ are separated and the separator sheet 30 or perforating sheet 31 is removed from between the comb bases 16′, 16″. When no perforating sheet 31 has been applied the perforation 19 can be formed on the comb bases 16′, 16″ subsequently with the aid of an adequate device, e.g. by a piked or thorny roller. Thereafter the frame parts 10′, 10″ are again introduced into the hive 100 in a separated form so that two types of passageways 15 and 150 are formed.

In the course of the pest treatment method connecting to the second embodiment initially the frame 1 is pulled out of the bee hive 100, the frame parts 10′, 10″ are opened by means of a connecting element 13, and the separator sheet 30 or perforating sheet 31 is removed from between the comb bases 16′, 16″ or the perforations 19 are created using a suitable tool or device. Inserts 300 are arranged on each comb bases 16′, 16″ as shown in FIG. 7b. The insert 300 has a thin substrate 302, from the surface of which—at least on one side—pins 304 are protruding which are longer than the thickness of the comb bases 16′, 16″ and contain a biological agent applicable for pest control. In order to make the insert 300 ready for use in the frames 1 both comb bases 16′, 16″ must be provided with perforations through which the pins 304 are penetrating into the comb cells 17 from the rear side according to FIG. 7b. It is advantageous if the insert 300 contains at least one pin 304 for every comb cell or at least for a considerable part of the comb cells 17. It is conceivable to provide an insert 300 with protruding pins 304 on its both sides, and this way one insert 300 alone can serve for both comb bases 16′, 16″.

The inserts 300 can be effective directly as well; in this case biological enemies of pathogen organisms can be applied to the surface of the pins 304 and can be introduced directly into the comb cells 17. Alternatively, in the inside of the pins 304 channels are running through and the inner surface of these channels is coated with sticky material and/or with a scented material which may attract the mites or other parasites. The channel of the pins 304 has a diameter such that an adult mite or other parasite can creep into it, which is about 1.2 mm in case of a Varroa Destructor. Alternatively, the size of the channels in the pins 304 makes possible for an evaporating chemical composition—fed in between the frame parts 10′, 10″ in their open position—to enter into the comb cells 17. Inserts 300 can be applied in combination with inserts 200. In this case the medicaments, chemical compositions, essences, organic acids do not enter directly into the comb cells 17 but by evaporation from the insert 200. This way the contamination of the wax material of the comb bases 16′, 16″ by chemicals can be prevented by the insert 200. After inserts 300 and/or 200 have been put in place, the frame parts 10′, 10″ of the bee frame can be loaded into the hive 100 in a tightly packed structure. The bees have no access or just limited access to the insert 200, which is advantageous for instance in case of application of biological agents, because these cannot be expelled out of the hive 100 by the bees.

In the second embodiment it is feasible to arrange a heated sheet 400 between the frame parts 10′, 10″. It is recommended to use such heated sheet out of the bee season. The heated insert 400 is placed predominantly in the part of the bee hive 100 where the queen lays her eggs. The comb bases 16′, 16″ of the invention have a smaller heat conduction coefficient which makes the heating more effective. The heated sheets 400 inserted into the frames 1 can be electrically connected to each other outside the frame 1 and can be operated from outside. The control of the connected heated inserts is effected by a control unit (not shown) dedicated to this purpose. Operating temperature of the heated insert 400 can be measured for instance by temperature sensors. As a result of this heating the brood cells are effectively protected against cold and various bee diseases like foul-brood and certain viral infections. This type of heating can ensure a better wintering and more intense development in the spring term.

1. A bee frame comprising a supporting frame with end bars and a comb base placed in the middle of the supporting frame, wherein the supporting frame is divided into two frame parts substantially along a central plane of the supporting frame, and within each frame part a respective comb base is fixed, and wherein the two frame parts with the respective comb bases are formed in a way that they can be closely joined together or be separated along their opposite surfaces, wherein the comb bases are provided with perforations in the alignment with the comb cells to be made by the bees.

2. The bee frame according to claim 1 wherein the two frame parts are formed as separate elements.

3. The bee frame according to claim 1 wherein the two frame parts are connected to each other along one of their bars by one or more connecting elements.

4. (canceled)

5. (canceled)

6. (canceled)

7. (canceled)

8. An insert for use in the bee frame of claim 1, wherein the insert is formed as a sheet and comprises a thin substrate is provided, at least on one side thereof, with pins in alignment with the perforations of the comb bases of the bee frame, said pins being slightly longer than the thickness of the comb bases.

9. (canceled)

10. (canceled)

11. The bee frame according to claim 1, further comprising an insert between the two comb bases, wherein the insert has a thin substrate provided, on both sides, with pins in alignment with said perforations of the comb bases, said pins being slightly longer than the thickness of the comb bases.

12. The bee frame according to claim 1, further comprising two inserts between the two comb bases, wherein each of the inserts has a thin substrate provided, on its sides facing the adjacent comb base, with pins in alignment with said perforations of the comb bases, said pins being slightly longer than the thickness of the comb bases.

13. The bee frame according to claim 11, wherein channels are formed in the pins for receiving mites or other parasites from the comb cells or for introducing evaporating chemical compositions into the comb cells.

14. The bee frame according to claim 11, wherein the pins are coated with biological agent for pest control.

15. The bee frame according to claim 12, wherein channels are formed in the pins for receiving mites or other parasites from the comb cells or for introducing evaporating chemical compositions into the comb cells.

16. The bee frame according to claim 12, wherein the pins are coated with biological agent for pest control.

17. The bee frame according to claim 1, wherein the comb bases are coated with wax, and a separator sheet is arranged between the comb bases to prevent sticking of the wax-coated comb bases, said separator sheet preferably being coated with a wax moth repellant material.
